(19) United States
(12) Patent Application Publication
(10) Pub. No.: US 2026/0221022 A1
(43) Pub. Date: Jul. 30, 2026

(54) DATA PROCESSING METHOD AND APPARATUS FOR HAPTIC MEDIA, COMPUTER DEVICE, AND STORAGE MEDIUM

(71) Applicant: Tencent Technology (Shenzhen) Company Limited, Shenzhen (CN)

(72) Inventors: Ying HU, Shenzhen (CN); Xiaozhong XU, Shenzhen (CN)

(21) Appl. No.: 19/571,004

(22) Filed: Mar. 18, 2026

Related U.S. Application Data
(63) Continuation of application No. PCT/CN2024/128148, filed on Oct. 29, 2024.

(30) Foreign Application Priority Data
Nov. 29, 2023 (CN) 202311622744.2

(51) Int. Cl. G08B 29/12; G08B 6/00

(52) U.S. Cl. CPC G08B 29/12; G08B 6/00

(57) ABSTRACT

This application provides a method for processing haptic media performed by a computer device. The data processing method for haptic media includes: acquiring representation information of a transient haptics signal in the haptic media, the representation information of the transient haptics signal being configured for indicating duration of the transient haptics signal; and presenting the transient haptics signal in the haptic media according to the representation information of the transient haptics signal. According to this application, the transient haptics signal in the haptic media may be accurately presented, thereby improving consumer experience of the haptic media.

### CROSS-REFERENCE TO RELATED APPLICATIONS

This application is a continuation application of PCT Patent Application No. PCT/CN2024/128148, entitled “DATA PROCESSING METHOD AND APPARATUS FOR HAPTIC MEDIA, COMPUTER DEVICE, AND STORAGE MEDIUM” filed on Oct. 29, 2024, which claims priority to Chinese Patent Application No. 202311622744.2, entitled “DATA PROCESSING METHOD AND APPARATUS FOR HAPTIC MEDIA, COMPUTER DEVICE, AND STORAGE MEDIUM” and filed with the China National Intellectual Property Administration on Nov. 29, 2023, both of which are incorporated herein by reference in their entirety.

### FIELD OF THE TECHNOLOGY

This application relates to the technical field of computers, and in particular, to the technical field of immersive media, specifically to a data processing method for haptic media, a data processing apparatus for haptic media, a computer device, and a computer-readable storage medium.

### BACKGROUND OF THE DISCLOSURE

With the continuous development of immersive media, in addition to conventional visual and auditory presentation, presentation manners of the immersive media further contain a new presentation manner, i.e., haptics, such as vibration haptics, electro-haptics, and pressure haptics. Immersive media presented in haptic form may be referred to as haptic media, which may include one or more haptics signals. Currently, a transient haptics signal in the haptic media is processed by a media presentation end, resulting in inaccurate presentation of the transient haptics signal. Consequently, the same transient haptics signal may be presented differently across different media presentation ends, thereby degrading the consumer experience of the haptic media. Therefore, how to accurately present the transient haptics signal in the haptic media and improve the consumer experience of the haptic media has become a current research hotspot.

### SUMMARY

Embodiments of this application provide a data processing method and apparatus for haptic media, a computer device, and a storage medium, which may accurately present a transient haptics signal in the haptic media, thereby improving consumer experience of the haptic media.

According to an aspect, the embodiments of this application provide a method for processing haptic media performed by a computer device, the method including:
acquiring representation information of a transient haptics signal in the haptic media, the representation information of the transient haptics signal being configured for indicating duration of the transient haptics signal; and
presenting the transient haptics signal in the haptic media according to the representation information of the transient haptics signal.

Correspondingly, the embodiments of this application provide a computer device, including:
a processor, adapted to implementing a computer program; and
a computer-readable storage medium, having the computer program stored therein, the computer program being adapted to being loaded by the processor and performing the foregoing data processing method for haptic media.

Correspondingly, the embodiments of this application provide a non-transitory computer-readable storage medium, having a computer program stored therein, the computer program, when read and executed by a processor of a computer device, causing the computer device to perform the foregoing data processing method for haptic media.

In the embodiments of this application, the representation information of the transient haptics signal in the haptic media is defined. The representation information of the transient haptics signal may be configured for indicating the duration of the transient haptics signal. That is, a presentation form of the transient haptics signal in the haptic media may be accurately defined through the representation information of the haptics signal, so that the transient haptics signal in the haptic media may be accurately presented based on the duration indicated by the representation information of the haptics signal, thereby improving the consumer experience of the haptic media.

### BRIEF DESCRIPTION OF THE DRAWINGS

FIG. 1A is a schematic diagram of 6 degrees of freedom (6DoF) according to an embodiment of this application.

FIG. 1B is a schematic diagram of 3DoF according to an embodiment of this application.

FIG. 1C is a schematic diagram of 3DoF+ according to an embodiment of this application.

FIG. 2 is a schematic diagram of a data structure of representation information of haptic media according to an embodiment of this application.

FIG. 3 is a schematic architectural diagram of a haptic media processing system according to an embodiment of this application.

FIG. 4 is a schematic flowchart of processing haptic media in a haptic media processing system according to an embodiment of this application.

FIG. 5 is a schematic flowchart of a data processing method for haptic media according to an embodiment of this application.

FIG. 6 is a schematic structural diagram of a bitstream file of haptic media according to an embodiment of this application.

FIG. 7 is a schematic flowchart of another data processing method for haptic media according to an embodiment of this application.

FIG. 8 is a schematic structural diagram of a data processing apparatus for haptic media according to an embodiment of this application.

FIG. 9 is a schematic structural diagram of a computer device according to an embodiment of this application.

### DESCRIPTION OF EMBODIMENTS

To more clearly understand technical solutions provided in embodiments of this application, some technical terms involved in this application are first introduced below.

### I. Immersive Media:

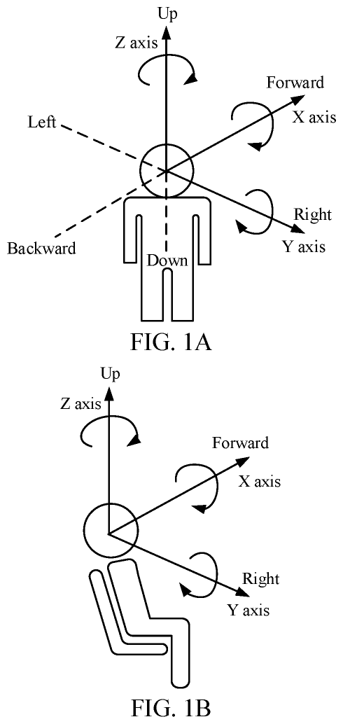

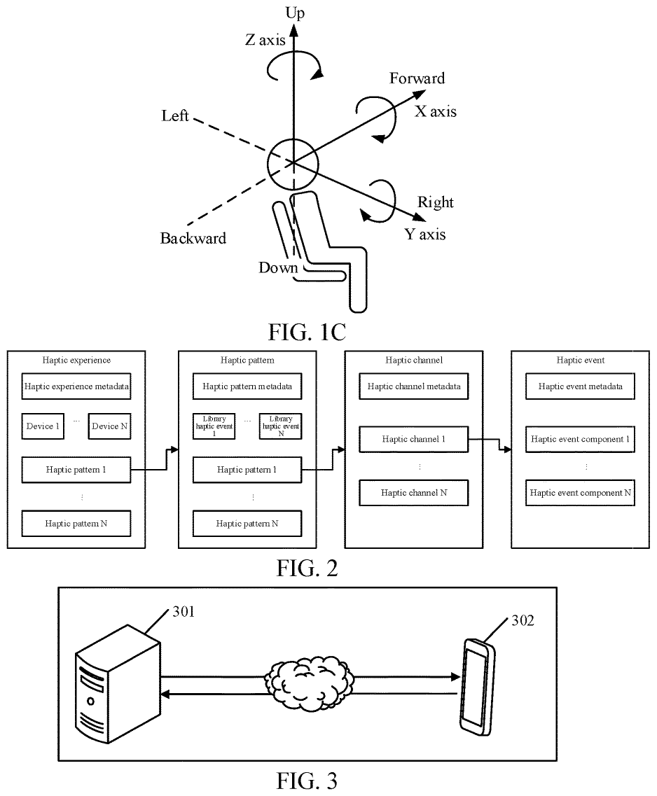

The immersive media refers to a media format file that can provide immersive media content so that a consumer immersed in the media content can obtain a visual experience, an auditory experience, a haptic experience, or the like in the real world. The immersive media may include, but is not limited to, at least one of the following (the term “at least one” in the embodiments of this application refers to one or more): audio media, video media, haptic media, and the like. The consumer may include, but is not limited to, at least one of the following: a listener of the audio media, a viewer of the video media, a user of the haptic media, and the like. The immersive media may be divided into 6DoF immersive media, 3DoF immersive media, and 3DoF+ immersive media according to the DoF of the consumer when consuming the media content. As shown in FIG. 1A, the 6DoF means that the consumer of the immersive media may freely translate along an X axis, a Y axis, and a Z axis. For example, the consumer of the immersive media may freely walk in three-dimensional and 360-degree virtual reality (VR) content. Similar to 6DoF, there are further 3DoF and 3DoF+ production techniques. As shown in FIG. 1B, 3DoF means that the consumer of immersive media is fixed at a center point of a three-dimensional space and rotates the head along the X axis, the Y axis, and the Z axis to view a picture provided by the media content. As shown in FIG. 1C, the 3DoF+ means that when a virtual scene provided by the immersive media has depth information, the head of the consumer of the immersive media may move in a limited space based on 3DoF to view the picture provided by the media content.

### II. Haptics:

Immersive media content is usually presented using various intelligent devices, such as a wearable device or an interactive device. Therefore, in addition to conventional visual and auditory presentation, presentation manners of the immersive media further include a new presentation manner, i.e., haptics. The haptics allows, through a haptics presentation mechanism combining hardware and software, the consumer to receive information through the body of the consumer, provides an embedded physical feeling, and transfers key information of a system that is being used by the consumer. For example, a device vibrates to remind a consumer of the device that a message is received. Such vibration is a presentation form of haptics. The haptics may further enhance auditory and visual presentation, thereby improving the consumer experience.

The haptics may contain, but is not limited to, one or more of the following: vibration haptic, kinematic haptics, and electro-haptics. The vibration haptics refers to simulating vibration of a particular frequency and intensity through vibration of a motor of a device. For example, in a shooting game, a particular effect when a shooting tool is used is simulated through vibration. The kinematic haptics refers to a kinematic haptic system simulating a weight or a pressure of an object, and it may contain, but is not limited to, a speed and an acceleration. For example, in a driving game, when a relatively heavy vehicle is moved or operated at a relatively high speed, a steering wheel may resist rotation. This type of feedback directly affects the consumer. In the example of the driving game, the consumer needs to apply a greater force to obtain a needed response from the steering wheel. In the electro-haptics, haptics stimulation is provided for nerve endings of the consumer using an electric pulse. The electro-haptics may create a highly realistic experience for a consumer wearing a suit or gloves equipped with an electro-haptics technology. Almost any feeling may be simulated by an electric pulse, such as a temperature change, a pressure change, and a sense of humidity. With the popularization of wearable devices and interactive devices, haptics sensed by the consumer when consuming the immersive media content may include omni-directional somatosensation such as vibration, pressure, speed, acceleration, temperature, humidity, and smell, which is more approximate to real-world haptics presentation experience.

### III. Haptic Media:

The haptic media refers to immersive media whose media type is a haptics type, and is a media format file that can provide the consumer with a real-world haptic experience. The haptic media may contain one or more haptics signals. The haptics signal is configured for representing a haptic experience of a particular modality, and can render a presented signal on a particular device. From the perspective of a presentation type, the haptics signal may include, but is not limited to: a vibration haptics signal, a pressure haptics signal, a speed haptics signal, a temperature haptics signal, and the like. According to different haptics signals, haptics types of the haptic media are also different. For example, if the haptics signal is the vibration haptics signal, the haptics type of the haptic media is vibration haptic media. For another example, if the haptics signal is an electro-haptics signal, the haptics type of the haptic media is electro-haptic media. From the perspective of presentation time, the haptics signal may include, but is not limited to, a transient haptics signal and a persistent haptics signal. Presentation duration of the persistent haptics signal is longer than that of the transient haptics signal. Particularly, for the vibration haptics signal, its duration may be measured using a quantity of times of vibration of a vibration motor at a base frequency. From the perspective of a presentation form, the haptics signal may include, but is not limited to, a reference haptics signal and an ordinary haptics signal. The reference haptics signal refers to a haptics signal with reference to a library haptics signal. The library haptics signal refers to a predefined and repeatedly referable haptics signal to avoid repeated parsing of the same haptics signal. The ordinary haptics signal refers to a haptics signal without reference to the library haptics signal.

Representation information of the haptic media may be configured for indicating attribute information of the haptic media. The attribute information of the haptic media is related to the presentation form of the haptic media. A data structure of the representation information of the haptic media is described below with reference to FIG. 2. FIG. 2 shows a data structure of representation information of audio video coding standard (AVS) haptic media. The data structure of the representation information of the haptic media is expanded hierarchically.

A highest-level data structure in the representation information of the haptic media is haptic experience, and may be configured for describing all haptic experience information in a file or a bitstream. The haptic experience includes metadata information related to the haptic experience, possible device information (for example, a device 1 to a device N in FIG. 2), and one or more haptic patterns (for example, a haptic pattern 1 to a haptic pattern N in FIG. 2). A haptic pattern corresponds to a haptics signal of a particular tactile type (for example, vibration, pressure, or temperature), and includes metadata information related to the haptic pattern, a library haptic event (for example, a library haptic event 1 to a library haptic event N in FIG. 2) that may be predefined, and one or more haptic channels (for example, a haptic channel 1 to a haptic channel N in FIG. 2). A haptic channel contains all or some haptics signals of a corresponding haptic pattern, and includes metadata information related to the haptic channel and one or more haptic events (for example, a haptic event 1 to a haptic event N in FIG. 2). Generally, in the same haptic pattern, haptics signals corresponding to different rendering devices may be organized into different haptic channels. A haptic event is a basic haptics signal unit, that is, one haptic event is equivalent to one haptics signal. The haptic event includes metadata information related to the haptic event and possible haptic event components (for example, a haptic event component 1 to a haptic event component N in FIG. 2). The haptic event component refers to a time-domain component or a frequency-domain component of the haptic event.

Data structures of the haptic experience, the haptic pattern, the library haptic event, the haptic channel, the haptic event, and the haptic event component are separately described below.

### 1. The Data Structure of the Haptic Experience is Defined as Shown in Table 1 Below.

TABLE 1
Data structure of haptic experience

| Attribute | Description |
|---|---|
| version | indicating standard version information followed by the haptic experience. |
| creation_date | indicating creation time of the haptic experience. |
| description | indicating description information of the haptic experience, defined by the user. |
| timescale | time scale of haptic experience, indicating a quantity of clock units contained in |
| | one second. |
| devices | device information element list, indicating one or more pieces of device |
| | information related to the haptic experience. |
| patterns | haptic pattern element list, indicating one or more haptic patterns contained in the |
| | haptic experience. |

Table 1 shows attribute information of haptic experience, including attribute information of the following attributes: version (a version field), creation_date (a creation time field), description (a description field), timescale (a time scale field), devices (a device information element list field), and patterns (a haptic pattern element list field).

A data structure of the device information is defined as shown in Table 2 below.

TABLE 2
Data structure of device information

| Attribute | Description |
|---|---|
| id | indicating an identifier of the device |
| device_name | indicating a (human eye-readable) name of the device |
| body_parts | indicating body parts corresponding to the device |

Table 2 shows the data structure of the device information, including attribute information of the following attributes: id (a device identification field), device_name (a device name field), and body_parts (a field of body parts corresponding to the device).

### 2. The Data Structure of the Haptic Pattern is Defined as Shown in Table 3 Below.

TABLE 3
Data structure of haptic pattern

| Attribute | Description |
|---|---|
| id | indicating an identifier of the haptic pattern. |
| pattern_type | indicating a type of the haptic pattern, with the following possible values: |
| | 1). vibration haptics; 2). pressure; 3). acceleration; 4). speed; 5). |
| | temperature; and 6). electro-haptics. |
| refer_devices | indicating devices corresponding to the haptic pattern. A value of the field |
| | corresponds to a device identifier defined in the device information. |
| event_semantics_flag | indicating whether semantics exist for a haptic event corresponding to the |
| | haptic pattern. |
| event_semantics_type | indicating a specification followed by semantics of the haptic event. |
| | Possible values of the field are as follows: |
| | 1). the semantics of the haptic event follows a specification defined in this |
| | standard; |
| | 2). the semantics of the haptic event follows a specification of an external |
| | standard; and |
| | 3). the semantics of the haptic event is defined by the user. |
| library_events | library haptic event element list, indicating library haptic events contained |
| | in the haptic pattern. |
| channels | haptic channel element list, indicating haptic channels contained in the |
| | haptic pattern. |

Table 3 shows the data structure of the haptic pattern, including attribute information of the following attributes: id (a haptic pattern identification field), pattern_type (a haptic pattern type field), refer_devices (a field of device identification corresponding to the haptic pattern), event_semantics_flag (a haptic pattern semantic indication field), event_semantics_type (a field of haptic event semantics following specification), library_events (a library haptic event element list field), and channels (a haptic channel element list field).

### 3. Data Structure of Library Haptic Event:

The library haptic event is a special haptic event, and the data structure of the library haptic event is defined following the data structure of the haptic event. The library haptic event is usually a predefined and repeatedly referable haptic event to avoid repeated parsing of the same haptic event.

### 4. The Data Structure of the Haptic Channel is Defined as Shown in Table 4 Below.

TABLE 4
Data structure of haptic channel

| Attribute | Description |
|---|---|
| id | indicating an identifier of the haptic channel. |
| description | indicating the description of the haptic channel, defined by the user. |
| refer_devices | indicating devices corresponding to the haptic pattern. A value of the field |
| | corresponds to a device identifier defined in the device information. |
| gain | indicating a gain of the haptic channel, the gain being applied to all events |
| | contained in the current channel and configured for restoring a normalized signal |
| | value to an original signal value, |
| | V = gain * x, |
| | where x is the normalized signal value, and V is the original signal value. |
| events | haptic event element list, indicating haptic events contained in the channel. |

Table 4 shows the data structure of the haptic channel, including attribute information of the following attributes: id (a haptic channel identifier field), description (a haptic channel description field), refer_devices (a field of devices corresponding to the haptic pattern), gain (a haptic channel gain field), and events (a haptic event element list field).

### 5. The Data Structure of the Haptic Event is Defined as Shown in Table 5 Below.

TABLE 5
Data structure of haptic event

| Attribute | Description |
|---|---|
| id | indicating an identifier of the haptic event |
| effect_semantic | indicating semantics of the haptic event. When a value of an |
| | event_semantics_flag field in a corresponding pattern is true, the attribute |
| | exists. |
| | The semantics of the haptic event is an event auxiliary information keyword |
| | that describes an intention of a content producer. |
| event_type | indicating a type of the haptic event, with the following possible values: |
| | 1). transient event; 2). persistent event; and 3). reference event. |
| refer_library_event | when the type of the haptic event is the reference event, the attribute exists, |
| | indicating a library haptic event identifier corresponding to the reference event. |
| relative_time | indicating a time offset of the haptic event. |
| duration | indicating duration of the haptic event. When the event type is the persistent |
| | event, the attribute exists. |
| amplitude | indicating a maximum signal amplitude value of the haptic event. |
| base_frequency | indicating a signal base frequency of the haptic event. |
| event_components | haptic event component element list, indicating a component of the haptic |
| | event. The haptic event component may be a time-domain component or a |
| | frequency-domain component of the haptic event. |

Table 5 shows the data structure of the haptic event, including attribute information of the following attributes: id (a haptic event identifier field), effect_semantic (a haptic event semantic field), event_type (a haptic event type field), refer_library_event (a reference library event field), relative_time (a time offset field), duration (a duration field), amplitude (an amplitude field), base_frequency (a base frequency field), and event_components (an event component field).

### 6. The Data Structure of the Haptic Event Component is Defined as Shown in Table 6 Below.

TABLE 6
Data structure of haptic event component

| Attribute | Description |
|---|---|
| refer_event_id | indicating an identifier of a haptic event to which the haptic event component |
| | belongs. |
| relative_time | indicating a time offset of the haptic event component relative to the haptic |
| | event. |
| relative_amplitude | indicating an amplitude value ratio of the haptic event component relative to |
| | the haptic event, ranging from 0 to 1. |
| relative_frequency | indicating a frequency offset of the haptic event component relative to the |
| | haptic event. |

Table 6 shows the data structure of the haptic event component, including attribute information of the following attributes: refer_event_id (a field of the identifier of the event to which the component belongs), relative_time (a field of the time offset of the component relative to the event), relative_amplitude (a field of the amplitude offset of the component relative to the event), and relative_frequency (a field of the frequency offset of the component relative to the event).

### IV. Track:

The track refers to a media data set in a media format file encapsulation process. One track includes a plurality of temporally ordered samples. One media format file may contain one or more tracks. Illustratively, one video media format file may contain, but is not limited to, a video media track, an audio media track, and a subtitle media track. Particularly, metadata information may alternatively be used as a media type, and is contained in the media format file in the form of a metadata track. The metadata information is a collective name for information related to presentation of the haptic media. The metadata information may include description information of media content of the haptic media, dependency information on which the haptic media depends, signaling information related to presentation of the media content of the haptic media, and the like. For example, metadata information related to the haptic experience may include description information of media content corresponding to the haptic experience, signaling information related to presentation of the media content corresponding to the haptic experience, and the like. Similarly, metadata information related to the haptic pattern may include description information of media content corresponding to the haptic pattern, signaling information related to presentation of the media content corresponding to the haptic pattern, and the like.

### V. International Organization for Standardization (ISO) Based Media File Format (ISOBMFF):

The ISOBMFF is an encapsulation standard for the media format file. The most typical ISOBMFF file is an MP4 file.

Based on the descriptions of the foregoing technical terms, the embodiments of this application provide a data processing method for haptic media. According to the data processing method for haptic media, representation information of a transient haptics signal in the haptic media is added. The representation information of the transient haptics signal may be configured for indicating the duration of the transient haptics signal. The presentation form of the transient haptics signal in the haptic media may be accurately defined through the representation information of the haptics signal, so that the transient haptics signal in the haptic media may be accurately presented, thereby improving the consumer experience of the haptic media.

In addition, in the data processing method for haptic media provided in the embodiments of this application, the representation information of the transient haptics signal may be added to an interchange format file of the haptic media. The interchange format file of the haptic media refers to the representation information of the haptic media, and may be configured for defining attribute information of the haptic media. The representation information of the transient haptics signal is added to the interchange format file of the haptic media, so that the transient haptics signal in the haptic media may be accurately presented at a presentation layer of the haptic media, thereby improving the consumer experience of the haptic media. In some embodiments, the representation information of the transient haptics signal may further be added to a bitstream file of the haptic media. The bitstream file of the haptic media is a binary bitstream obtained by compressing (that is, encoding) the interchange format file of the haptic media. The representation information of the transient haptics signal is added to the bitstream file of the haptic media, so that the haptic media may be correspondingly processed at a bitstream layer of the haptic media. In some embodiments, the representation information of the transient haptics signal may further be added to the media format file of the haptic media. The media format file of the haptic media is obtained by encapsulating the bitstream file of the haptic media. The representation information of the transient haptics signal is added to the media format file of the haptic media, so that the haptic media may be correspondingly processed at an encapsulation layer of the haptic media.

A haptic media processing system provided in the embodiments of this application is described below. The haptic media processing system may be applied to the data processing method for haptic media provided in the embodiments of this application.

As shown in FIG. 3, the haptic media processing system may include a service device 301 and a consumption device 302. The service device 301 may be used as an encoder side of the haptic media to encode and encapsulate the haptic media, so as to form a media format file of the haptic media. The consumption device 302 may be used as a decoder side (or may be referred to as the aforementioned media presentation end) of the haptic media to decapsulate, decode, and consume the media format file of the haptic media, so as to present the haptic media. A connection mode between the service device 301 and the consumption device 302 is not limited in the embodiments of this application. A direct communication connection may be established between the service device 301 and the consumption device 302 through wired communication, or an indirect communication connection may be established between the service device 301 and the consumption device 302 through wireless communication.

The service device 301 may be a terminal device or a server. The consumption device 302 may also be a terminal device or a server. The terminal device may be a smartphone, a tablet computer, a notebook computer, a desktop computer, a smart speaker, a smart watch, an in-vehicle terminal, a smart television, a smart wearable device, a smart interactive device, or the like, but is not limited thereto. The server may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

In addition, a transmission process of the haptic media is involved between the service device 301 and the consumption device 302. The transmission process may be performed based on various transmission protocols (or transmission signaling). The transmission protocols herein may include, but are not limited to, a dynamic adaptive streaming over hypertext transfer protocol (HTTP) (DASH) protocol, an HTTP live streaming (HLS) protocol, a smart media transport protocol (SMTP), a transmission control protocol (TCP), and the like.

When the service device 301 performs the data processing method for haptic media provided in the embodiments of this application, the following data processing processes are mainly involved: (1) an acquisition process of the haptic media; and (2) an encoding and file encapsulation process of the haptic media. When the consumption device 302 performs the data processing method for haptic media provided in the embodiments of this application, the following data processing processes are mainly involved: (3) a file decapsulation and decoding process of the haptic media; and (4) a presentation process of the haptic media. The data processing processes of the service device 301 and the consumption device 302 are separately described below.

### (1) Acquisition Process of Haptic Media.

The service device 301 may acquire the haptic media and generate an interchange format file of the haptic media. The interchange format file of the haptic media contains representation information of a transient haptics signal. In detail, the service device 301 may acquire the haptic media, and the haptic media may contain one or more haptics signals. For different haptics signals, manners for acquiring corresponding haptic media may be different. For example, for a vibration haptics signal, a manner for acquiring corresponding vibration haptic media may involve collecting a vibration haptics signal having a particular frequency and intensity through a capture device (such as a sensor) associated with the service device 301. Here, “associated” means that the service device 301 may communicate with the capture device, and the capture device may transmit a collected haptics signal to the service device 301. For another example, for an electro-haptics signal, a manner for acquiring corresponding electro-haptic media may involve capturing electric pulses through a capture device associated with the service device 301 to generate the electro-haptics signal. The capture device may be determined according to a type of the collected haptics signal, and may include, but is not limited to, a camera device, a sensing device, and a scanning device. The camera device may include an ordinary camera, a stereoscopic camera, a light field camera, and the like. The sensing device may include a laser device, a radar device, and the like. The scanning device may include a three-dimensional laser scanning device, and the like.

### (2) Encoding and File Encapsulation Process of Haptic Media.

The service device 301 may encode the interchange format file of the haptic media to obtain a bitstream file of the haptic media. The service device 301 may encapsulate the bitstream file of the haptic media to obtain an encapsulated file of the haptic media.

In some embodiments, the service device 301 may add the representation information of the transient haptics signal to the bitstream file of the haptic media. Alternatively, the service device 301 may add the representation information of the transient haptics signal to the media format file of the haptic media.

### (3) File Decapsulation and Decoding Process of Haptic Media.

The consumption device 302 may obtain the media format file of the haptic media and corresponding media presentation description information through the service device 301. The media presentation description information contains related information of the media format file of the haptic media. The file decapsulation process of the consumption device 302 is the inverse of the file encapsulation process of the service device 301. The consumption device 302 decapsulates the media format file according to a file format requirement of the haptic media to obtain the bitstream file of the haptic media. The decoding process of the consumption device 302 is the inverse of the encoding process of the service device 301. The consumption device 302 decodes the bitstream file of the haptic media to restore the interchange format file of the haptic media. The interchange format file of the haptic media may include the representation information of the transient haptics signal.

In some embodiments, if the representation information of the transient haptics signal is added to the encapsulation process of the haptic media, the representation information of the transient haptics signal may be obtained through decapsulation in the decapsulation process of the haptic media. Alternatively, if identification information of the transient haptics signal is added to the encoding process of the haptic media, the representation information of the transient haptics signal may be obtained through decoding in the decoding process of the haptic media.

### (4) Presentation Process of Haptic Media.

The consumption device 302 may render the interchange format file of the haptic media obtained through decoding, to present the haptic media. Particularly, the consumption device 302 may render the representation information of the transient haptics signal of the interchange format file of the haptic media to present the transient haptics signal in the haptic media.

Further, the foregoing data processing processes of the service device 301 and the consumption device 302 may be summarized as a schematic flowchart shown in FIG. 4. As shown in FIG. 4, the service device 301 may collect haptic media B, the haptic media containing a transient haptics signal A; generate an interchange format file of the haptic media B, the interchange format file of the haptic media B containing representation information of the transient haptics signal A; encode the interchange format file of the haptic media B to obtain a bitstream file E of the haptic media; and encapsulate the bitstream file E of the haptic media to obtain a media format file of the haptic media. In addition, the service device 301 may further add the representation information of the transient haptics signal to the bitstream file of the haptic media, and may further add the representation information of the transient haptics signal to the media format file of the haptic media.

Particularly, the service device 301 synthesizes, according to a particular media container file format, the bitstream file E of the haptic media into a media format file F configured for file playback or an initialization segment and a segment (Fs) of the media format file configured for streaming transmission. That is, the media format file of the haptic media may include the media format file F or the segment Fs of the media format file. The media container file format may be an ISO basic media file format specified in ISO/International Electrotechnical Commission (IEC) 14496-12.

The consumption device 302 may receive the media format file of the haptic media transmitted by the service device 301. The media format file may include: a media format file F′ configured for file playback, or an initialization segment and a segment Fs' of the media format file configured for streaming transmission. The consumption device 302 may decapsulate the media format file of the bitstream file E of the haptic media to obtain a bitstream file E′ of the haptic media, and may decode the bitstream file E′ of the haptic media to obtain an interchange format file of haptic media D′. The interchange format file of the haptic media D′ includes representation information of a transient haptics signal A′. The consumption device 302 may render the haptic media D′ according to the interchange format file of the haptic media D′ to present the haptic media D′. Particularly, the consumption device 302 may render the transient haptics signal A′ according to the representation information of the transient haptics signal A′ to present the transient haptics signal A′. In addition, the consumption device 302 may further acquire the representation information of the transient haptics signal from the bitstream file of the haptic media, and may further acquire the representation information of the transient haptics signal from the media format file of the haptic media.

The data processing procedure of the haptic media in the foregoing haptic media processing system may be applied to haptics feedback-related products, and links such as a service node (i.e., an encoder side), a consumption node (i.e., a decoder side), and an intermediate node (i.e., a relay side) of an immersive system. The data processing method for haptic media provided in this application may be implemented using cloud technology. A cloud server implemented based on cloud technology is used as the encoder side or the decoder side. The cloud technology refers to a hosting technology that unifies a series of resources such as hardware, software, and networks in a wide area network or a local area network to implement data calculation, storage, processing, and sharing.

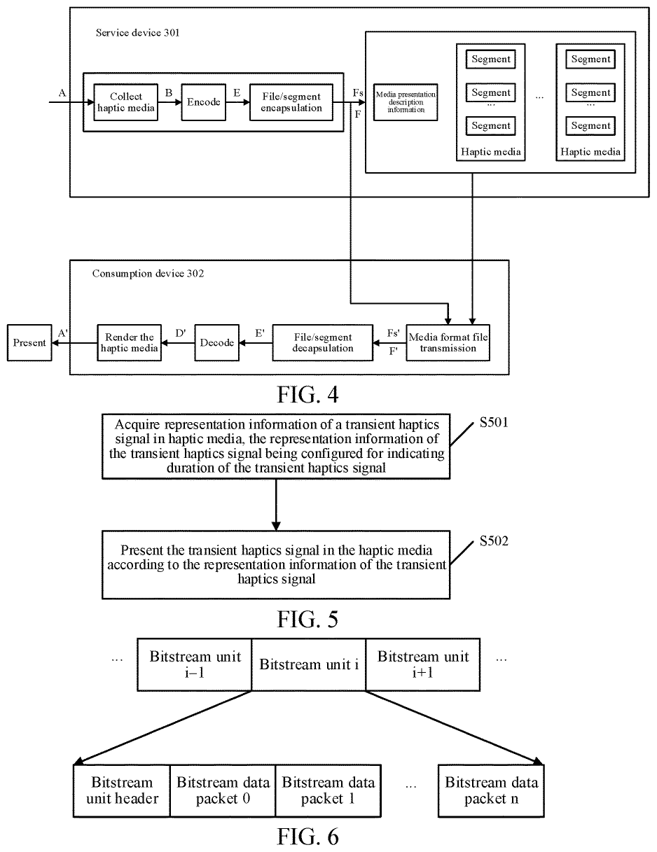

The embodiments of this application provide a data processing method for haptic media. The data processing method for haptic media mainly introduces representation information of a transient haptics signal added at a decoder side. The data processing method for haptic media may be performed by a computer device, and the computer device may be, for example, the consumption device 302 in the haptic media processing system shown in FIG. 3. As shown in FIG. 5, the data processing method for haptic media may include operation S501 to operation S502.

S501: Acquire representation information of a transient haptics signal in the haptic media, the representation information of the transient haptics signal being configured for indicating duration of the transient haptics signal.

Manners for acquiring the representation information of the transient haptics signal in the haptic media may include at least one of the following: a first manner: acquiring the representation information of the transient haptics signal from an interchange format file of the haptic media; a second manner: acquiring the representation information of the transient haptics signal from a bitstream file of the haptic media; and a third manner: acquiring the representation information of the transient haptics signal from a media format file of the haptic media. These three manners for acquiring the representation information of the transient haptics signal are separately described below.

I. Acquire the Representation Information of the Transient Haptics Signal from the Interchange Format File of the Haptic Media:

In this manner for acquiring the representation information of the transient haptics signal, the interchange format file of the haptic media may be acquired. The interchange format file of the haptic media may be configured for defining attribute information of the haptic media. A manner for acquiring the interchange format file of the haptic media may include: decapsulating the media format file of the haptic media to obtain the bitstream file of the haptic media, and decoding the bitstream file of the haptic media to obtain the interchange format file of the haptic media. In this manner for acquiring the interchange format file of the haptic media, the consumption device 302 may be understood as a decoder side of the haptic media. Alternatively, the interchange format file of the haptic media may be generated. In this manner for acquiring the interchange format file of the haptic media, the consumption device 302 may be understood as an encoder side and a decoder side of the haptic media, and may manufacture and present the haptic media by itself.

Further, manners for acquiring the representation information of the transient haptics signal in the interchange format file of the haptic media may include any one of the following: acquiring the representation information of the transient haptics signal from a data structure of a haptic pattern, acquiring the representation information of the transient haptics signal from a data structure of a library haptic event, and acquiring the representation information of the transient haptics signal from a data structure of a haptic event. Three manners for acquiring the representation information of the transient haptics signal in the interchange format file of the haptic media are separately described below.

(1) Acquire the Representation Information of the Transient Haptics Signal from the Data Structure of the Haptic Pattern:

The interchange format file of the haptic media may include the data structure of the haptic pattern, and the data structure of the haptic pattern may be configured for defining attribute information of the haptic pattern. The haptic pattern may contain one or more haptic channels and related metadata. One haptic pattern corresponds to a haptics signal of one haptics type. After the representation information of the transient haptics signal is added, the data structure (AVS_haptics_pattern) of the haptic pattern is shown in Table 7 below.

TABLE 7
Data structure of haptic pattern

| | | Default | | Mandatory |
|---|---|---|---|---|
| Attribute | Data type | value | Description | or not |
| id | integer | None | indicating an identifier of the haptic pattern. A value | Yes |
| | | | of the field needs to be greater than or equal to 0 | |
| pattern_type | enum<string> | None | indicating a type of the haptic pattern, with the | Yes |
| | | | following possible values: | |
| | | | 1). vibration haptics; 2). pressure; 3). acceleration; | |
| | | | 4). speed; 5). temperature; and 6). electro-haptics. | |
| refer_devices | array<integer> | None | indicating devices corresponding to the haptic | No |
| | | | pattern. A value of the field corresponds to a device | |
| | | | identifier defined in the device information. | |
| event_semantics_flag | bool | None | indicating whether semantics exist for a haptic event | No |
| | | | corresponding to the haptic pattern. | |
| event_semantics_type | integer | None | indicating a specification followed by semantics of | Mandatory |
| | | | the haptic event. Possible values of the field are as | |
| | | | follows: | |
| | | | 1). the semantics of the haptic event follows a | |
| | | | specification defined in this standard; | |
| | | | 2). the semantics of the haptic event follows a | |
| | | | specification of an external standard; and | |
| | | | 3). the semantics of the haptic event is defined by the | |
| | | | user. | |
| transient_duration | integer | None | indicating duration of a transient haptics signal in a | Yes |
| | | | current haptic pattern. A time scale timescale is used | |
| | | | as a unit, and transient_duration/timescale is a | |
| | | | quantity of seconds for which a transient signal lasts. | |
| library_events | array<AVS_{—} | None | library haptic event element list, indicating library | No |
| | haptics_event> | | haptic events contained in the haptic pattern. | |
| channels | array<AVS_{—} | None | haptic channel element list, indicating haptic | Yes |
| | haptics_channel> | | channels contained in the haptic pattern. | |

By comparing the data structure of the haptic pattern in Table 7 with that in Table 3 before adding the representation information of the transient haptics signal, it may be learned that after the representation information of the transient haptics signal is added, the data structure of the haptic pattern may include a transient duration field (transient_duration). The representation information of the transient haptics signal may include the transient duration field, and the transient duration field may be configured for indicating the duration of the transient haptics signal in the current haptic pattern. In addition, when the time scale timescale is used as a unit, transient_duration/timescale may be configured for indicating a quantity of seconds for which the transient haptics signal lasts.

In some embodiments, for the vibration haptics, transient_duration may further be defined according to a base frequency of a vibration motor. That is, a quantity of times that the vibration motor vibrates at the base frequency is indicated through transient_duration. In this case, semantics of transient_duration is as follows: indicating a measurement of a transient vibration signal in a vibration haptic pattern. A value of the field indicates the quantity of times that the vibration motor vibrates at the base frequency. That is, the data structure of the haptic pattern may further include a haptic pattern type field (pattern_type), and the haptic pattern type field may be configured for indicating a type of the haptic pattern of the haptic media. When the haptic pattern type field indicates that the type of the haptic pattern of the haptic media is vibration haptics, the transient duration field may be configured for indicating that duration of a transient haptics signal in a current vibration haptic pattern is the quantity of times that the vibration motor vibrates at the base frequency.

(2) Acquire the Representation Information of the Transient Haptics Signal from the Data Structure of the Library Haptic Event:

The interchange format file of the haptic media may include the data structure of the library haptic event, and the data structure of the library haptic event may be configured for defining attribute information of the library haptic event. The library haptic event is a special haptic event, and the data structure of the library haptic event may be defined following the data structure of the haptic event. The library haptic event is usually a predefined and repeatedly referable haptic event to avoid repeated parsing of the same haptic event. That is, for the representation information of the transient haptics signal, a special library haptic event may be defined using a currently defined library haptic event, to represent duration of a transient haptics signal in a corresponding haptic pattern. After the representation information of the transient haptics signal is added, the data structure of the library haptic event is shown in Table 8 below.

TABLE 8
Data structure of library haptic event

| | | Default | | Mandatory |
|---|---|---|---|---|
| Attribute | Data type | value | Description | or not |
| id | integer | None | indicating an identifier of the haptic event. | Yes |
| effect_semantic | string | None | indicating semantics of the haptic event. When a | Mandatory |
| | | | value of an event_semantics_flag field in a | |
| | | | corresponding pattern is true, the attribute exists. | |
| | | | The semantics of the haptic event is an event | |
| | | | auxiliary information keyword that describes an | |
| | | | intention of a content producer. | |
| event_type | enum<string> | None | indicating a type of the haptic event, with the | Yes |
| | | | following possible values: | |
| | | | a transient event; | |
| | | | a persistent event; and | |
| | | | a reference event. | |
| | | | (For the library haptic event, a value of the field can | |
| | | | only be the transient event or the persistent event.) | |
| refer_library_event | integer | None | When the type of the haptic event is the reference | Mandatory |
| | | | event, the attribute exists, indicating a library haptic | |
| | | | event identifier corresponding to the reference event. | |
| | | | (For the library haptic event, the field is not | |
| | | | available.) | |
| relative_time | integer | None | indicating a time offset of the haptic event. | No |
| | | | (For the library haptic event, the field is not | |
| | | | available.) | |
| duration | integer | None | indicating duration of the haptic event. | No |
| | | | (For the library haptic event, if the event type is the | |
| | | | transient event and the field is available, the field | |
| | | | indicates duration of all transient events in a current | |
| | | | haptic pattern. For one haptic pattern, there is only | |
| | | | one transient library haptic event having the duration | |
| | | | field. | |
| | | | If the event type is the persistent event, the field | |
| | | | needs to be available, and indicates duration of a | |
| | | | corresponding library haptic event. | |
| | | | In the field, the time scale timescale is used as a unit, | |
| | | | and transient_duration/timescale is a quantity of | |
| | | | seconds for which a transient signal lasts.) | |
| amplitude | integer | None | indicating a maximum signal amplitude value of the | Yes |
| | | | haptic event. | |
| | | | (For a library haptic event whose event type is the | |
| | | | transient event and has the duration field, the field is | |
| | | | not available.) | |
| base_frequency | integer | None | indicating a signal base frequency of the haptic | Yes |
| | | | event. | |
| | | | (For a library haptic event whose event type is the | |
| | | | transient event and has the duration field, the field is | |
| | | | not available.) | |
| event_components | array<AVS_haptics_{—} | None | haptic event component element list, indicating a | No |
| | event_component> | | component of the haptic event. The haptic event | |
| | | | component may be a time-domain component or a | |
| | | | frequency-domain component of the haptic event. | |
| | | | (For a library haptic event whose event type is the | |
| | | | transient event and has the duration field, the element | |
| | | | list is not available.) | |

By comparing the data structure of the haptic pattern in Table 8 with that in Table 5 before adding the representation information of the transient haptics signal, it may be learned that after the representation information of the transient haptics signal is added, the data structure of the library haptic event may include a haptic event type field (event_type). The haptic event type field may be configured for indicating an event type of the library haptic event of the haptic media, and the event type includes the transient event or the persistent event. When the haptic event type field indicates that the event type of the library haptic event of the haptic media is the transient event, and the data structure of the library haptic event further includes a duration field (duration), the representation information of the transient haptics signal may include the duration field. The duration field may be configured for indicating duration of all transient haptic events in the current haptic pattern. One haptic pattern has one library haptic event having the duration field and having the event type of the transient event.

In this case, for the persistent event, when the haptic event type field indicates that the event type of the library haptic event of the haptic media is the persistent event, the duration field may be configured for indicating duration of a corresponding library haptic event.

By continuing to compare the data structure of the haptic pattern in Table 8 with that in Table 5 before adding the representation information of the transient haptics signal, it may be learned that the data structure of the library haptic event is determined according to the data structure of the haptic event. The data structure of the haptic event may contain a reference library event field (refer_library_event), the data structure of the library haptic event may not contain the reference library event field, and the reference library event field may be configured for indicating a library haptic event identifier corresponding to the haptic event when the event type of the haptic event is the reference event. The data structure of the haptic event may contain a relative time field (relative_time), the data structure of the library haptic event may not contain the relative time field, and the relative time field may be configured for indicating a time offset of the haptic event.

The data structure of the haptic event may contain an amplitude field (amplitude), a base frequency field (base_frequency), and an event component field (event_components). When the haptic event type field indicates that the event type of the library haptic event of the haptic media is the transient event, and the data structure of the library haptic event includes the duration field, the data structure of the library haptic event may not contain the amplitude field, the base frequency field, and the event component field. The amplitude field may be configured for indicating the maximum signal amplitude value of the haptic event. The base frequency field may be configured for indicating the signal base frequency of the haptic event. The event component field may be configured for indicating the haptic event component element list. The haptic event component element list is configured for indicating the component of the haptic event, and the component of the haptic event includes the time-domain component or the frequency-domain component of the haptic event.

(3) Acquire the Representation Information of the Transient Haptics Signal from the Data Structure of the Haptic Event:

The interchange format file of the haptic media may include the data structure of the haptic event, the data structure of the haptic event may be configured for defining attribute information of the haptic event, and the haptic event may contain a complete haptics signal and related metadata. The representation information of the transient haptics signal may further be directly combined with a currently defined persistent haptics signal. That is, for the representation information of the haptic media, there are only two types of haptic events, i.e., an ordinary event and a reference event. The ordinary event is a haptics signal that does not refer to the library haptic event. The ordinary event necessarily has a persistent event. The reference event is a haptics signal that needs to refer to the library haptic event. After the representation information of the transient haptics signal is added, the data structure (AVS_haptics_event) of the haptic event is shown in Table 9 below.

TABLE 9
Data structure of haptic event

| | | Default | | Mandatory |
|---|---|---|---|---|
| Attribute | Data type | value | Description | or not |
| id | integer | None | indicating an identifier of the haptic event | Yes |
| effect_semantic | string | None | indicating semantics of the haptic event. When a | Selectable |
| | | | value of an event_semantics_flag field in a | |
| | | | corresponding pattern is true, the attribute may exist. | |
| | | | The semantics of the haptic event is an event | |
| | | | auxiliary information keyword that describes an | |
| | | | intention of a content producer. | |
| event_type | enum<string> | None | (indicating a type of the haptic event, with the | Yes |
| | | | following possible values: | |
| | | | 1). an ordinary event; and | |
| | | | 2). a reference event.) | |
| refer_library_event | integer | None | When the type of the haptic event is the reference | Mandatory |
| | | | event, the attribute exists, indicating a library haptic | |
| | | | event identifier corresponding to the reference event. | |
| relative_time | integer | None | indicating a time offset of the haptic event. (When | No |
| | | | the haptic event is the ordinary event, this field | |
| | | | exists.) | |
| duration | integer | None | indicating duration of the haptic event. | Yes |
| amplitude | integer | None | indicating a maximum signal amplitude value of the | Yes |
| | | | haptic event. | |
| base_frequency | integer | None | indicating a signal base frequency of the haptic | Yes |
| | | | event. | |
| event_components | array<AVS_haptics_{—} | None | haptic event component element list, indicating a | No |
| | event_component> | | component of the haptic event. The haptic event | |
| | | | component may be a time-domain component or a | |
| | | | frequency-domain component of the haptic event. | |

By comparing the data structure of the haptic pattern in Table 9 with that in Table 5 before adding the representation information of the transient haptics signal, it may be learned that after the representation information of the transient haptics signal is added, the data structure of the haptic event includes a haptic event type field (event_type). The haptic event type field may be configured for indicating the event type of the haptic event of the haptic media, and the event type includes the reference event or the ordinary event. When the haptic event type field indicates that the event type of the haptic event of the haptic media is the reference event, the data structure of the haptic event further includes the reference library event field (refer_library_event), and the representation information of the transient haptics signal may include the reference library event field. The reference library event field may be configured for indicating the library haptic event identifier corresponding to the haptic event having the event type of the reference event. Duration of the haptic event having the event type of the reference event is the same as duration of a library haptic event indicated by a corresponding library haptic event identifier.

For the ordinary event, when the haptic event type field indicates that the event type of the haptic event of the haptic media is the ordinary event, the data structure of the haptic event may further include the relative time field (relative_time), and the relative time field may be configured for indicating the time offset of the haptic event.

II. Acquire the Representation Information of the Transient Haptics Signal from the Bitstream File of the Haptic Media:

In this manner for acquiring the representation information of the transient haptics signal, the bitstream file of the haptic media may be acquired. At an encoder side, the bitstream file of the haptic media may be obtained by encoding the interchange format file of the haptic media. At a decoder side, the bitstream file of the haptic media may be obtained by decapsulating the media format file of the haptic media. As shown in FIG. 6, after the interchange format file of the haptic media is compressed into a binary bitstream (that is, the bitstream file of the haptic media), data in the interchange format file exists in the binary bitstream in the form of packets. Specifically, the bitstream file of the haptic media may include a plurality of bitstream units (for example, . . . , a bitstream unit i−1, a bitstream unit i, a bitstream unit i+1, and . . . in FIG. 6). Each bitstream unit may contain a bitstream unit header and a plurality of bitstream data packets (for example, the bitstream unit i in FIG. 6 contains a bitstream unit header and a bitstream data packet 0 to a bitstream data packet n), and each bitstream data packet may be considered as a data unit in the binary bitstream. Particularly, there are some data units configured for containing metadata in the interchange format file, for example, a haptic pattern metadata packet and a library haptic event metadata packet. The haptic pattern metadata packet may be obtained by encoding haptic pattern metadata, and the library haptic event metadata packet may be obtained by encoding library haptic event metadata.

Further, manners for acquiring the representation information of the transient haptics signal in the bitstream file of the haptic media may include any one of the following: acquiring the representation information of the transient haptics signal from the haptic pattern metadata packet, and acquiring the representation information of the transient haptics signal from the library haptic event metadata packet. Two manners for acquiring the representation information of the transient haptics signal in the bitstream file of the haptic media are separately described below.

(1) Acquire the Representation Information of the Transient Haptics Signal from the Haptic Pattern Metadata Packet:

Syntax of the haptic pattern metadata packet (readMetadataPattern( )) is shown in Table 10 below.

TABLE 10

| | Quantity | |
|---|---|---|
| Syntax | of bits | Mnemonic |
| readMetadataPattern( ) | | |
| { | | |
| id; | 8 | uimsbf |
| patternType; | 8 | uimsbf |
| eventLibraryCount; | 16 | uimsbf |
| sementicsFlag; | 1 | boolean |
| if(sementicsFlag){ | | |
| semantics_type | 8 | uimsbf |
| } | | |
| transient_duration | 16 | uimsbf |
| referenceDeviceCount; | 8 | uimsbf |
| for (i = 0; i < referenceDeviceCount; i++) { | | |
| referenceDeviceId; | 8 | uimsbf |
| } | | |
| channelCount; | 8 | uimsbf |
| } | | |

Syntactic elements in the haptic pattern metadata packet shown in Table 10 are explained as follows.

id (a haptic pattern identification field): indicates an identifier of the haptic pattern. A value of the field needs to be greater than or equal to 0.

pattern Type (a haptic pattern type field): indicates a type of the haptic pattern. A value of the field has meanings shown in Table 11 below.

TABLE 11

| Value | Meaning |
|---|---|
| 0 | Vibration haptics |
| 1 | Pressure |
| 2 | Acceleration |
| 3 | Speed |
| 4 | Temperature |
| 5 | Electro-haptics |
| 6-255 | Reserved |

eventLibraryCount (a library haptic event quantity field): indicates a quantity of library haptic events.

sementicsFlag (a haptic pattern semantic flag field): indicates whether semantics exist for a haptic event corresponding to the haptic pattern.

event_semantics_type (a field of haptic event semantics following specification): indicates a specification followed by semantics of the haptic event. When a value of the field is 0, the semantics of the haptic event follows a specification defined in this standard. When the value is 1, the semantics of the haptic event follows a specification of an external standard. When the value is 2, the semantics of the haptic event is defined by the user.

transient_duration (a transient duration field): indicates duration of a transient haptics signal in a current haptic pattern. A time scale timescale is used as a unit, and transient_duration/timescale is a quantity of seconds for which a transient signal lasts. (Corresponding to an exemplary solution of acquiring the duration of the transient haptics signal from the interchange format file of the haptic media, the meaning of the field may further be: indicating a measurement of a transient vibration signal in a vibration haptic pattern. A value of the field indicates the quantity of times that the vibration motor vibrates at the base frequency.)

referenceDeviceCount (a field of a quantity of devices corresponding to the haptic pattern): indicates the quantity of devices corresponding to the haptic pattern.

referenceDeviceId (a field of device identification corresponding to the haptic pattern): indicates an identifier of the device corresponding to the haptic pattern.

Based on the syntax of the haptic pattern metadata packet shown in Table 10, it may be learned that the haptic pattern metadata packet of the haptic media may include the transient duration field (transient_duration). The representation information of the transient haptics signal may include the transient duration field, and the transient duration field may be configured for indicating the duration of the transient haptics signal in the current haptic pattern.

In some embodiments, for vibration haptics, the haptic pattern metadata packet may further include a haptic pattern type field (pattern_type), and the haptic pattern type field may be configured for indicating a type of the haptic pattern of the haptic media. When the haptic pattern type field indicates that the type of the haptic pattern of the haptic media is vibration haptics, the transient duration field is configured for indicating that duration of a transient haptics signal in a current vibration haptic pattern may be the quantity of times that the vibration motor vibrates at the base frequency.

(2) Acquire the Representation Information of the Transient Haptics Signal from the Library Haptic Event Metadata Packet:

Syntax of the library haptic event metadata packet (readLibraryEvents( )) is shown in Table 12 below.

TABLE 12

| | Quantity | |
|---|---|---|
| Syntax | of bits | Mnemonic |
| readLibraryEvents( ) { | | |
| id; | 16 | |
| eventType | 2 | uimsbf |
| hasSemantic | 1 | boolean |
| if(hasSemantic){ | | |
| semanticKeywords | 12 | uimsbf |
| } | | |
| durationFlag | 1 | boolean |
| if(durationFlag){ | | |
| durationTime | 16 | uimsbf |
| } | | |
| baseFrequency | 16 | uimsbf |
| baseAmplitude | 8 | uimsbf |
| eventComponentsCount; | 16 | uimsbf |
| for (i = 0; i < eventComponentsCount; i++) { | | |
| mask; | 3 | uimsbf |
| if (mask & 0x001) { | | |
| relativeTime; | 16 | uimsbf |
| } | | |
| if (mask & 0x010) { | | |
| relativeAmplitude; | 8 | uimsbf |
| } | | |
| if (mask & 0x100) { | | |
| relativeFrequency; | 16 | uimsbf |
| } | | |
| } | | |
| } | | |

Syntactic elements in the library haptic event metadata packet shown in Table 12 are explained as follows.

id (a haptic event identifier field): indicates an identifier of the haptic event.

eventType (a haptic event type field): indicating a type of the haptic event. When a value is 0, a transient event is indicated. When the value of is 1, a persistent event is indicated. When the value of is 2, a reference event is indicated. For a library haptics signal, the value of the field cannot be 2.

hasSemantic (a haptic event semantic indication field): when a value is 0, indicates that the event has no semantics, and when the value is 1, indicates that the event has special semantics.

semanticKeywords (a haptic event semantic field): represents the semantics of the event.

durationFlag (a duration flag field): when a value is 0, the duration of the event is not indicated, and when the value is 1, the duration of the event is indicated.

duration Time (a duration field): indicates the duration of the event. For the library haptic event, if the event type is the transient event and the field is available, the field indicates duration of all transient events in a current haptic pattern. For one haptic pattern, there is only one transient library haptic event having the duration field.

If the event type is the persistent event, the field needs to be available, and indicates duration of a corresponding library haptic event.

In the field, the time scale timescale is used as a unit, and transient_duration/timescale is a quantity of seconds for which a transient signal lasts.

baseFrequency (a base frequency field): indicates a signal base frequency of the haptic event.

baseAmplitude (a base amplitude field): indicates a maximum signal amplitude value of the haptic event.

eventComponentsCount (a field of a quantity of components of the haptic event): indicates the quantity of event components contained in the haptic event.

Mask (a haptic event component control field): is configured for controlling a corresponding field indication of the haptic event component.

relativeTime (a relative time field): indicates a time offset value of the haptic event component relative to the haptic event.

relativeAmplitude (a relative amplitude field): indicates an amplitude offset value of the haptic event component relative to the haptic event.

relativeFrequency (a relative frequency field): indicates a frequency offset value of the haptic event component relative to the haptic event.

Based on the syntax of the library haptic event metadata packet shown in Table 12, it may be learned that the library haptic event metadata packet may include an event type field (eventType) and a duration flag field (durationFlag). The event type field may be configured for indicating an event type of the library haptic event, and the event type may include a transient event or a persistent event. The duration flag field may be configured for indicating whether to indicate the duration of the library haptic event. If the duration flag field indicates that the duration of the library haptic event needs to be indicated, the library haptic event metadata packet may further include a duration field (durationTime), and the representation information of the transient haptics signal may include the duration field. If the event type field indicates that the event type of the library haptic event of the haptic media is the transient event, the duration field may be configured for indicating duration of all transient haptics signals in the current haptic pattern. One haptic pattern has one library haptic event having the duration field and having the event type of the transient event.

In this case, for the persistent event, when the event type field indicates that the event type of the library haptic event of the haptic media is the persistent event, the duration field may be configured for indicating duration of a corresponding library haptic event.

III. Acquire the Representation Information of the Transient Haptics Signal from the Media Format File of the Haptic Media:

In this manner for acquiring the representation information of the transient haptics signal, the media format file of the haptic media may be acquired. At an encoder side, the media format file of the haptic media may be acquired by encoding the bitstream file of the haptic media. At a decoder side, the media format file of the haptic media may be transmitted by the encoder side. The representation information of the transient haptics signal is specifically acquired from a haptic pattern description data box in the media format file of the haptic media. The haptic pattern description data box may be configured for indicating metadata information of the haptic pattern of the haptic media. Syntax of the haptic pattern description data box (HapticPatternDescriptionBox( )) is described herein first. The syntax of the haptic pattern description data box is as follows:

```
aligned(8) class HapticPatternDescriptionBox( )
  extends FullBox(‘hpde’, version = 0, flags= 0) {
  unsigned int(8) pattern_id;
  unsigned int(8) pattern_type;
  unsigned int(1) event_semantics_flag;
  if(event_semantics_flag == 1){
unsigned int(8) event_semantics_type
}
unsigned int(16) transient_duration;
  unsigned int(16) library_event_count;
}
```

Syntactic elements of the haptic pattern description data box are explained as follows.

pattern_id (a haptic pattern identification field): indicates an identifier of the haptic pattern. A value of the field needs to be greater than or equal to 0.

pattern_type (a haptic pattern type field): indicates a type of the haptic pattern. A value of the field has meanings shown in Table 11 above.

library_event_count (a library haptic event quantity field): indicates a quantity of library haptic events.

event_semantics_flag (a haptic pattern semantic flag field): indicates whether semantics exist for a haptic event corresponding to the haptic pattern.

event_semantics_type (a field of haptic event semantics following specification): indicates a specification followed by semantics of the haptic event. When a value of the field is 0, the semantics of the haptic event follows a specification defined in this standard. When the value is 1, the semantics of the haptic event follows a specification of an external standard. When the value is 2, the semantics of the haptic event is defined by the user.

transient_duration (a transient duration field): indicates duration of a transient haptics signal in a current haptic pattern. A time scale timescale is used as a unit, and transient_duration/timescale is a quantity of seconds for which a transient signal lasts. (Corresponding to an exemplary solution of acquiring the duration of the transient haptics signal from the interchange format file of the haptic media, the meaning of the field may further be: indicating a measurement of a transient vibration signal in a vibration haptic pattern. A value of the field indicates the quantity of times that the vibration motor vibrates at the base frequency.)

Based on the syntax of the foregoing haptic pattern description data box, it may be learned that the haptic pattern description data box may include a transient duration field (transient_duration). The representation information of the transient haptics signal may include the transient duration field, and the transient duration field may be configured for indicating the duration of the transient haptics signal in the current haptic pattern.

In some embodiments, for the vibration haptic, the haptic pattern description data box may further include a haptic pattern type field (pattern_type), and the haptic pattern type field may be configured for indicating a type of the haptic pattern of the haptic media. When the haptic pattern type field indicates that the type of the haptic pattern of the haptic media is vibration haptics, the transient duration field is configured for indicating that duration of a transient haptics signal in a current vibration haptic pattern may be the quantity of times that the vibration motor vibrates at the base frequency.

S502: Present the transient haptics signal in the haptic media according to the representation information of the transient haptics signal.

After the representation information of the transient haptics signal is acquired, the representation information of the transient haptics signal may be rendered to obtain the transient haptics signal.

In the embodiments of this application, the representation information of the transient haptics signal in the haptic media is defined. The representation information of the transient haptics signal may be configured for indicating the duration of the transient haptics signal. That is, the presentation form of the transient haptics signal in the haptic media may be accurately defined through the representation information of the haptics signal, so that the transient haptics signal in the haptic media may be accurately presented, thereby improving the consumer experience of the haptic media.

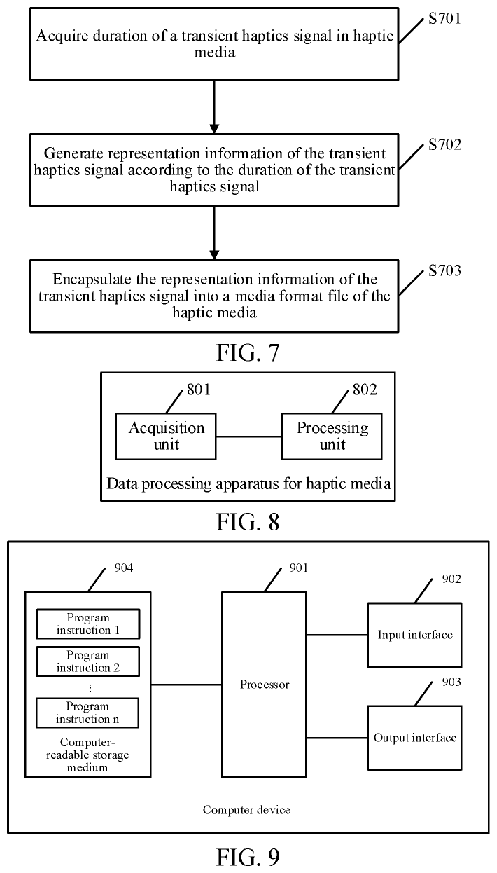

The embodiments of this application provide a data processing method for haptic media. The data processing method for haptic media mainly introduces representation information of a transient haptics signal added at an encoder side. The data processing method for haptic media may be performed by a computer device, and the computer device may be, for example, the service device 301 in the haptic media processing system shown in FIG. 3. As shown in FIG. 7, the data processing method for haptic media may include operation S701 to operation S703.

S701: Acquire duration of a transient haptics signal in the haptic media.

S702: Generate representation information of the transient haptics signal according to the duration of the transient haptics signal.

S703: Encapsulate the representation information of the transient haptics signal into a media format file of the haptic media.

The representation information of the transient haptics signal may be defined in an interchange format file of the haptic media. That is, the interchange format file of the haptic media may include the representation information of the transient haptics signal. In this case, encapsulating the representation information of the transient haptics signal into the media format file of the haptic media may include: encoding the interchange format file of the haptic media to obtain a bitstream file of the haptic media; and encapsulating the bitstream file of the haptic media to obtain the media format file of the haptic media.

Further, the interchange format file of the haptic media may include at least a data structure of a haptic pattern, a data structure of a library haptic event, and a data structure of a haptic event. Defining the representation information of the transient haptics signal in the interchange format file of the haptic media may include at least any one of the following cases: the representation information of the transient haptics signal may be defined in the data structure of the haptic pattern, the representation information of the transient haptics signal may be defined in the data structure of the library haptic event, and the representation information of the transient haptics signal may be defined in the data structure of the haptic event. The three cases are separately described below.

### (1) the Representation Information of the Transient Haptics Signal is Defined in the Data Structure of the Haptic Pattern:

The data structure of the haptic pattern may be configured for defining attribute information of the haptic pattern of the haptic media, and includes a transient duration field. In this case, the representation information of the transient haptics signal may include the transient duration field. The generating representation information of the transient haptics signal according to the duration of the transient haptics signal may include: setting a value of the transient duration field to the duration of the transient haptics signal.

In some embodiments, for vibration haptics, the data structure of the haptic pattern may further include a haptic pattern type field, and the haptic pattern type field may be configured for indicating a type of the haptic pattern of the haptic media. When the haptic pattern type field indicates that the type of the haptic pattern of the haptic media is vibration haptics, the duration of the transient haptics signal may refer to a quantity of times that a vibration motor vibrates at a base frequency.

### (2) the Representation Information of the Transient Haptics Signal is Defined in the Data Structure of the Library Haptic Event:

The data structure of the library haptic event may be configured for defining attribute information of the library haptic event of the haptic media, and includes a haptic event type field. The haptic event type field may be configured for indicating an event type of the library haptic event of the haptic media, and the event type may include a transient event or a persistent event. When the haptic event type field indicates that the event type of the library haptic event of the haptic media is the transient event, and the data structure of the library haptic event further includes a duration field, the representation information of the transient haptics signal may include the duration field. In this case, the generating representation information of the transient haptics signal according to the duration of the transient haptics signal may include: setting a value of the duration field to the duration of the transient haptics signal, where one haptic pattern has one library haptic event having the duration field and having the event type of the transient event.

In this case, for the persistent event, when the haptic event type field indicates that the event type of the library haptic event of the haptic media is the persistent event, the duration field may be configured for indicating duration of a corresponding library haptic event.

Particularly, the data structure of the library haptic event may be determined according to the data structure of the haptic event. The data structure of the haptic event may contain a reference library event field, the data structure of the library haptic event may not contain the reference library event field, and the reference library event field may be configured for indicating a library haptic event identifier corresponding to the haptic event when an event type of the haptic event is a reference event. The data structure of the haptic event may contain a relative time field, the data structure of the library haptic event may not contain the relative time field, and the relative time field may be configured for indicating a time offset of the haptic event.

In addition, the data structure of the library haptic event may be determined according to the data structure of the haptic event, and the data structure of the haptic event may contain an amplitude field, a base frequency field, and an event component field. When the haptic event type field indicates that the event type of the library haptic event of the haptic media is the transient event, and the data structure of the library haptic event includes the duration field, the data structure of the library haptic event may not contain the amplitude field, the base frequency field, and the event component field. The amplitude field may be configured for indicating a maximum signal amplitude value of the haptic event. The base frequency field may be configured for indicating a signal base frequency of the haptic event. The event component field may be configured for indicating a haptic event component element list. The haptic event component element list may be configured for indicating a component of the haptic event, and the component of the haptic event may include a time-domain component or a frequency-domain component of the haptic event.

### (3) the Representation Information of the Transient Haptics Signal is Defined in the Data Structure of the Haptic Event:

The data structure of the haptic event may be configured for defining attribute information of the haptic event of the haptic media, and may include a haptic event type field. The haptic event type field may be configured for indicating the event type of the haptic event of the haptic media, and the event type may include the reference event or an ordinary event. When the event type field indicates that the event type of the haptic event of the media is the reference event, the data structure of the reference event further includes a reference library event field, and the representation information of the haptics signal may include the reference library event field. In this case, the generating representation information of the haptics signal according to the duration of the haptics signal may include: setting a value of the reference library event field to the library haptic event identifier corresponding to the haptic event having the event type of the reference event, where duration of the haptic event having the event type of the reference event is the same as duration of a library haptic event indicated by a corresponding library haptic event identifier.

In some embodiments, for the ordinary event, when the haptic event type field indicates that the event type of the haptic event of the haptic media is the ordinary event, the data structure of the haptic event may further include the relative time field, and the relative time field may be configured for indicating the time offset of the haptic event.

Operation S701 to operation S703 mainly describe a process of encapsulating the representation information of the transient haptics signal into the media format file of the haptic media when the interchange format file of the haptic media contains the representation information of the transient haptics signal. In some embodiments, the representation information of the haptics signal may further be added to the bitstream file of the haptic media, and the bitstream file of the haptic media is encapsulated to obtain the media format file of the haptic media. The bitstream file of the haptic media may include at least one of the following: a haptic pattern metadata packet and a library haptic event metadata packet. That is, the representation information of the haptics signal may be added to the haptic pattern metadata packet, or the representation information of the haptics signal may be added to the library haptic event metadata packet. The two cases are separately described below.

### 1). Add the Representation Information of the Haptics Signal to the Haptic Pattern Metadata Packet:

The haptic pattern metadata packet may be obtained by encoding haptic pattern metadata, and the representation information of the transient haptics signal may be added to the haptic pattern metadata packet. The haptic pattern metadata packet of the haptic media may include a transient duration field, and the representation information of the transient haptics signal may include the transient duration field. In this case, the generating representation information of the transient haptics signal according to the duration of the transient haptics signal may include: setting a value of the transient duration field to the duration of the transient haptics signal.

In some embodiments, for vibration haptics, the haptic pattern metadata packet may further include a haptic pattern type field, and the haptic pattern type field may be configured for indicating a type of the haptic pattern of the haptic media. When the haptic pattern type field indicates that the type of the haptic pattern of the haptic media is vibration haptics, the duration of the transient haptics signal may refer to a quantity of times that a vibration motor vibrates at a base frequency.

### 2). Add the Representation Information of the Haptics Signal to the Library Haptic Event Metadata Packet:

The library haptic event metadata packet may be obtained by encoding library haptic event metadata, and the representation information of the transient haptics signal may be added to the library haptic event metadata packet. The library haptic event metadata packet may include a haptic event type field and a duration flag field. The haptic event type field may be configured for indicating an event type of a library haptic event, and the event type may include a transient event or a persistent event. The duration flag field may be configured for indicating whether to indicate duration of the library haptic event. In this case, the generating representation information of the transient haptics signal according to the duration of the transient haptics signal may include: setting a value of the duration flag field to a first preset value to indicate that the duration of the library haptic event needs to be indicated; adding a duration field to the library haptic event metadata packet, the representation information of the transient haptics signal including the duration field; and setting a value of the duration field to the duration of the transient haptics signal. When the haptic event type field indicates that the event type of the library haptic event of the haptic media is the transient event, the duration field may be configured for indicating duration of all transient haptics signals in the current haptic pattern. One haptic pattern has one library haptic event having the duration field and having the event type of the transient event.

In this case, for the persistent event, when the haptic event type field indicates that the event type of the library haptic event of the haptic media is the persistent event, the duration field may be configured for indicating duration of a corresponding library haptic event.

The foregoing 1) to 2) describe the case in which the representation information of the transient haptics signal is added to the bitstream file of the haptic media. In some embodiments, the representation information of the transient haptics signal is further added to the media format file of the haptic media.

Specifically, the media format file of the haptic media may include a haptic pattern description data box. The haptic pattern description data box may be configured for indicating metadata information of the haptic pattern of the haptic media, and the representation information of the transient haptics signal is added to the haptic pattern description data box. The haptic pattern description data box may include a transient duration field, and the representation information of the transient haptics signal may include the transient duration field. In this case, the generating representation information of the transient haptics signal according to the duration of the transient haptics signal may include: setting a value of the transient duration field to the duration of the transient haptics signal.

In some embodiments, for vibration haptics, the haptic pattern description data box may further include a haptic pattern type field, and the haptic pattern type field may be configured for indicating a type of the haptic pattern of the haptic media. When the haptic pattern type field indicates that the type of the haptic pattern of the haptic media is vibration haptics, the duration of the transient haptics signal may refer to a quantity of times that a vibration motor vibrates at a base frequency.

In the embodiments of this application, the representation information of the transient haptics signal in the haptic media is defined. The representation information of the transient haptics signal may be configured for indicating the duration of the transient haptics signal. That is, the presentation form of the transient haptics signal in the haptic media may be accurately defined through the representation information of the haptics signal, so that the transient haptics signal in the haptic media may be accurately presented, thereby improving the consumer experience of the haptic media.

FIG. 8 is a schematic structural diagram of a data processing apparatus for haptic media according to an embodiment of this application. The data processing apparatus for haptic media may be provided in a computer device provided in the embodiments of this application, and the computer device may be the consumption device 302 in the haptic media processing system shown in FIG. 3. The data processing apparatus for haptic media shown in FIG. 8 may be a computer program running on the computer device, and may be configured to perform some or all operations in the method embodiment shown in FIG. 5. Referring to FIG. 8, the data processing apparatus for haptic media may include the following units:
an acquisition unit 801, configured to acquire representation information of a transient haptics signal in the haptic media, the representation information of the transient haptics signal being configured for indicating duration of the transient haptics signal; and
a processing unit 802, configured to present the transient haptics signal in the haptic media according to the representation information of the transient haptics signal.

In an implementation, the acquisition unit 801 is specifically configured to, during the acquisition of the representation information of the transient haptics signal in the haptic media, perform the following operations: acquiring an interchange format file of the haptic media; and acquiring the representation information of the transient haptics signal from the interchange format file of the haptic media.

In an implementation, the interchange format file of the haptic media includes a data structure of a haptic pattern of the haptic media, and the data structure of the haptic pattern is configured for defining attribute information of the haptic pattern of the haptic media, and includes a transient duration field; and the representation information of the transient haptics signal includes the transient duration field, and the transient duration field is configured for indicating duration of a transient haptics signal in a current haptic pattern.

In an implementation, the data structure of the haptic pattern further includes a haptic pattern type field, and the haptic pattern type field is configured for indicating a type of the haptic pattern of the haptic media; and when the haptic pattern type field indicates that the type of the haptic pattern of the haptic media is vibration haptics, the transient duration field is configured for indicating that duration of a transient haptics signal in a current vibration haptic pattern is a quantity of times that a vibration motor vibrates at a base frequency.

In an implementation, the interchange format file of the haptic media includes a data structure of a library haptic event of the haptic media, and the data structure of the library haptic event is configured for defining attribute information of the library haptic event of the haptic media, and includes a haptic event type field; the haptic event type field is configured for indicating an event type of the library haptic event of the haptic media, and the event type includes a transient event or a persistent event; and when the haptic event type field indicates that the event type of the library haptic event of the haptic media is the transient event, and the data structure of the library haptic event further includes a duration field, the representation information of the transient haptics signal includes the duration field; the duration field is configured for indicating duration of all transient haptic events in the current haptic pattern, where one haptic pattern has one library haptic event having the duration field and having the event type of the transient event.

In an implementation, when the haptic event type field indicates that the event type of the library haptic event of the haptic media is the persistent event, the duration field is configured for indicating duration of a corresponding library haptic event.

In an implementation, the data structure of the library haptic event is determined according to a data structure of a haptic event; the data structure of the haptic event contains a reference library event field, the data structure of the library haptic event does not contain the reference library event field, and the reference library event field is configured for indicating a library haptic event identifier corresponding to the haptic event when an event type of the haptic event is a reference event; and the data structure of the haptic event contains a relative time field, the data structure of the library haptic event does not contain the relative time field, and the relative time field is configured for indicating a time offset of the haptic event.

In an implementation, the data structure of the library haptic event is determined according to the data structure of the haptic event, and the data structure of the haptic event contains an amplitude field, a base frequency field, and an event component field; when the haptic event type field indicates that the event type of the library haptic event of the haptic media is the transient event, and the data structure of the library haptic event includes the duration field, the data structure of the library haptic event does not contain the amplitude field, the base frequency field, and the event component field; the amplitude field is configured for indicating a maximum signal amplitude value of the haptic event; the base frequency field is configured for indicating a signal base frequency of the haptic event; the event component field is configured for indicating a haptic event component element list; and the haptic event component element list is configured for indicating a component of the haptic event, and the component of the haptic event includes a time-domain component or a frequency-domain component of the haptic event.

In an implementation, the interchange format file of the haptic media includes the data structure of the haptic event of the haptic media, and the data structure of the haptic event is configured for defining attribute information of the haptic event of the haptic media, and includes a haptic event type field; the haptic event type field is configured for indicating the event type of the haptic event of the haptic media, and the event type includes the reference event or an ordinary event; when the haptic event type field indicates that the event type of the haptic event of the haptic media is the reference event, the data structure of the haptic event further includes the reference library event field, and the representation information of the transient haptics signal includes the reference library event field; and the reference library event field is configured for indicating the library haptic event identifier corresponding to the haptic event having the event type of the reference event, where duration of the haptic event having the event type of the reference event is the same as duration of a library haptic event indicated by a corresponding library haptic event identifier.

In an implementation, when the haptic event type field indicates that the event type of the haptic event of the haptic media is the ordinary event, the data structure of the haptic event further includes the relative time field, and the relative time field is configured for indicating the time offset of the haptic event.

In an implementation, the acquisition unit 801 is specifically configured to, during the acquisition of the representation information of the transient haptics signal in the haptic media, perform the following operations: acquiring a bitstream file of the haptic media; and acquiring the representation information of the transient haptics signal from the bitstream file of the haptic media.

In an implementation, the bitstream file of the haptic media includes a haptic pattern metadata packet, and the haptic pattern metadata packet is obtained by encoding haptic pattern metadata; the haptic pattern metadata packet of the haptic media includes a transient duration field; and the representation information of the transient haptics signal includes the transient duration field, and the transient duration field is configured for indicating duration of a transient haptics signal in a current haptic pattern.

In an implementation, the haptic pattern metadata packet further includes a haptic pattern type field, and the haptic pattern type field is configured for indicating a type of a haptic pattern of the haptic media; and when the haptic pattern type field indicates that the type of the haptic pattern of the haptic media is vibration haptics, the transient duration field is configured for indicating that duration of a transient haptics signal in a current vibration haptic pattern is a quantity of times that a vibration motor vibrates at a base frequency.

In an implementation, the bitstream file of the haptic media includes a library haptic event metadata packet, and the library haptic event metadata packet is obtained by encoding library haptic event metadata; the library haptic event metadata packet includes an event type field and a duration flag field; the event type field is configured for indicating an event type of the library haptic event, and the event type includes a transient event or a persistent event; the duration flag field is configured for indicating whether to indicate duration of the library haptic event; if the duration flag field indicates that the duration of the library haptic event needs to be indicated, the library haptic event metadata packet further includes a duration field, and the representation information of the transient haptics signal includes the duration field; and if the event type field indicates that the event type of the library haptic event of the haptic media is the transient event, the duration field is configured for indicating duration of all transient haptics signals in the current haptic pattern, where one haptic pattern has one library haptic event having the duration field and having the event type of the transient event.

In an implementation, when the event type field indicates that the event type of the library haptic event of the haptic media is the persistent event, the duration field is configured for indicating duration of a corresponding library haptic event.

In an implementation, the acquisition unit 801 is specifically configured to, during the acquisition of the representation information of the transient haptics signal in the haptic media, perform the following operations: acquiring a media format file of the haptic media; and acquiring the representation information of the transient haptics signal from the media format file of the haptic media.

In an implementation, the media format file of the haptic media includes a haptic pattern description data box, and the haptic pattern description data box is configured for indicating metadata information of the haptic pattern of the haptic media; the haptic pattern description data box includes a transient duration field; and the representation information of the transient haptics signal includes the transient duration field, and the transient duration field is configured for indicating duration of a transient haptics signal in a current haptic pattern.

In an implementation, the haptic pattern description data box further includes a haptic pattern type field, and the haptic pattern type field is configured for indicating a type of a haptic pattern of the haptic media; and when the haptic pattern type field indicates that the type of the haptic pattern of the haptic media is vibration haptics, the transient duration field is configured for indicating that duration of a transient haptics signal in a current vibration haptic pattern is a quantity of times that a vibration motor vibrates at a base frequency.

In an implementation, the processing unit 802 is specifically configured to, during the presentation of the transient haptics signal in the haptic media according to the representation information of the transient haptics signal, perform the following operation: rendering the representation information of the transient haptics signal to obtain the transient haptics signal.

According to another embodiment of this application, the units in the data processing apparatus for haptic media shown in FIG. 8 may be separately or wholly combined into one or several other units, or one (or more) of the units may further be divided into a plurality of units having smaller functions. In this way, same operations may be implemented, and the implementation of the technical effects of the embodiments of this application is not affected. The foregoing units are divided based on logical functions. In practical application, a function of one unit may further be implemented by a plurality of units, or functions of a plurality of units are implemented by one unit. In other embodiments of this application, the data processing apparatus for haptic media may further include other units. In practical application, these functions may alternatively be cooperatively implemented by other units, and may be cooperatively implemented by a plurality of units.

According to another embodiment of this application, a computer program that can perform the operations involved in some or all of the method shown in FIG. 5 may be run on a general-purpose computing device such as a computer that includes processing elements and storage elements such as a central processing unit (CPU), a random access memory (RAM), and a read-only memory (ROM), to construct the data processing apparatus for haptic media shown in FIG. 8 and implement the data processing method for haptic media in the embodiments of this application. The computer program may be recorded in, for example, a computer-readable storage medium, loaded into the computing device through the computer-readable storage medium, and run on the computing device.

In the embodiments of this application, the representation information of the transient haptics signal in the haptic media is defined. The representation information of the transient haptics signal may be configured for indicating the duration of the transient haptics signal. That is, the presentation form of the transient haptics signal in the haptic media may be accurately defined through the representation information of the haptics signal, so that the transient haptics signal in the haptic media may be accurately presented, thereby improving the consumer experience of the haptic media.

FIG. 8 is a schematic structural diagram of a data processing apparatus for haptic media according to an embodiment of this application. The data processing apparatus for haptic media may be provided in a computer device provided in the embodiments of this application, and the computer device may be the service device 301 in the haptic media processing system shown in FIG. 3. The data processing apparatus for haptic media shown in FIG. 8 may be a computer program running on the computer device, and may be configured to perform some or all operations in the method embodiment shown in FIG. 7. Referring to FIG. 8, the data processing apparatus for haptic media may include the following units:

an acquisition unit 801, configured to acquire duration of a transient haptics signal in the haptic media; and

a processing unit 802, configured to generate representation information of the transient haptics signal according to the duration of the transient haptics signal.

The processing unit 802 is further configured to encapsulate the representation information of the transient haptics signal into a media format file of the haptic media.

In an implementation, an interchange format file of the haptic media includes the representation information of the transient haptics signal. The processing unit 802 is specifically configured to, during the encapsulating of the representation information of the transient haptics signal into the media format file of the haptic media, perform the following operations: encoding the interchange format file of the haptic media to obtain a bitstream file of the haptic media; and encapsulating the bitstream file of the haptic media to obtain the media format file of the haptic media.

In an implementation, the processing unit 802 is further configured to perform the following operation: adding the representation information of the transient haptics signal to the bitstream file of the haptic media.

In an implementation, the processing unit 802 is further configured to perform the following operation: adding the representation information of the transient haptics signal to the media format file of the haptic media.

According to another embodiment of this application, the units in the data processing apparatus for haptic media shown in FIG. 8 may be separately or wholly combined into one or several other units, or one (or more) of the units may further be divided into a plurality of units having smaller functions. In this way, same operations may be implemented, and the implementation of the technical effects of the embodiments of this application is not affected. The foregoing units are divided based on logical functions. In practical application, a function of one unit may further be implemented by a plurality of units, or functions of a plurality of units are implemented by one unit. In other embodiments of this application, the data processing apparatus for haptic media may further include other units. In practical application, these functions may alternatively be cooperatively implemented by other units, and may be cooperatively implemented by a plurality of units.

According to another embodiment of this application, a computer program that can perform the operations involved in some or all of the method shown in FIG. 7 may be run on a general-purpose computing device such as a computer that includes processing elements and storage elements such as a CPU, a RAM, and a ROM, to construct the data processing apparatus for haptic media shown in FIG. 8 and implement the data processing method for haptic media in the embodiments of this application. The computer program may be recorded in, for example, a computer-readable storage medium, loaded into the computing device through the computer-readable storage medium, and run on the computing device.

In the embodiments of this application, the representation information of the transient haptics signal in the haptic media is defined. The representation information of the transient haptics signal may be configured for indicating the duration of the transient haptics signal. That is, the presentation form of the transient haptics signal in the haptic media may be accurately defined through the representation information of the haptics signal, so that the transient haptics signal in the haptic media may be accurately presented, thereby improving the consumer experience of the haptic media.

FIG. 9 is a schematic structural diagram of a computer device according to an embodiment of this application. The computer device shown in FIG. 9 includes at least a processor 901, an input interface 902, an output interface 903, and a computer-readable storage medium 904. The processor 901, the input interface 902, the output interface 903, and the computer-readable storage medium 904 may be connected through a bus or in another manner.

The computer-readable storage medium 904 may be stored in a memory of the computer device. The computer-readable storage medium 904 is configured to store a computer program, and the computer program includes computer instructions. The processor 901 is configured to execute the computer program stored in the computer-readable storage medium 904. The processor 901 (or referred to as a CPU) is a computing core and a control core of the computer device, is adapted to implementing the computer program, and is specifically adapted to loading and executing the computer program to implement a corresponding method procedure or a corresponding function.

The embodiments of this application further provide a computer-readable storage medium (memory). The computer-readable storage medium is a memory device in a computer device, and is configured to store a program and data. The computer-readable storage medium herein may include an internal storage medium of the computer device, and certainly may further include an expanded storage medium supported by the computer device. The computer-readable storage medium provides storage space, and the storage space stores an operating system of the computer device. In addition, the storage space further stores a computer program adapted to being loaded and executed by the processor. The computer-readable storage medium herein may be a high-speed RAM, or may be a non-volatile memory, for example, at least one magnetic disk memory. In some embodiments, it may alternatively be at least one computer-readable storage medium located far away from the foregoing processor.

In some embodiments, the computer device may be the consumption device 302 in the haptic media processing system shown in FIG. 3, and the processor 901 may load and execute the computer program stored in the computer-readable storage medium 904 to implement corresponding operations of the data processing method for haptic media shown in FIG. 5.

In other embodiments, the computer device may be the service device 301 in the haptic media processing system shown in FIG. 3, and the processor 901 may load and execute the computer program stored in the computer-readable storage medium 904 to implement corresponding operations of the data processing method for haptic media shown in FIG. 7.

In the embodiments of this application, the representation information of the transient haptics signal in the haptic media is defined. The representation information of the transient haptics signal may be configured for indicating the duration of the transient haptics signal. That is, the presentation form of the transient haptics signal in the haptic media may be accurately defined through the representation information of the haptics signal, so that the transient haptics signal in the haptic media may be accurately presented, thereby improving the consumer experience of the haptic media.

The embodiments of this application further provide a computer program product, including a computer program, the computer program being stored in a computer-readable storage medium. A processor of a computer device reads the computer program from the computer-readable storage medium and executes the computer program to cause the computer device to perform the foregoing data processing method for haptic media.

A person skilled in the art may recognize that the exemplary units and algorithm operations described with reference to the embodiments disclosed in this specification may be implemented in electronic hardware or in a combination of computer software and electronic hardware. Whether these functions are implemented in hardware or software depends on the specific application and design constraints of the technical solutions. For each particular application, a person skilled in the art may use different methods to achieve the described function, but this implementation shall not be considered outside the scope of this application.

What is claimed is:

1. A method for processing haptic media performed by a computer device, the method comprising:
acquiring representation information of a transient haptics signal in the haptic media, the representation information of the transient haptics signal indicating duration of the transient haptics signal; and
presenting the transient haptics signal in the haptic media according to the representation information of the transient haptics signal.

2. The method according to claim 1, wherein the acquiring representation information of a transient haptics signal in the haptic media comprises:
acquiring an interchange format file of the haptic media; and
acquiring the representation information of the transient haptics signal from the interchange format file of the haptic media.

3. The method according to claim 2, wherein the interchange format file of the haptic media comprises a data structure of a haptic pattern of the haptic media, and the data structure of the haptic pattern is configured for defining attribute information of the haptic pattern of the haptic media, and comprises a transient duration field; and
the representation information of the transient haptics signal comprises the transient duration field, and the transient duration field is configured for indicating duration of a transient haptics signal in a current haptic pattern.

4. The method according to claim 3, wherein the data structure of the haptic pattern further comprises a haptic pattern type field, and the haptic pattern type field is configured for indicating a type of the haptic pattern of the haptic media; and
when the haptic pattern type field indicates that the type of the haptic pattern of the haptic media is vibration haptics, the transient duration field is configured for indicating that duration of a transient haptics signal in a current vibration haptic pattern is a quantity of times that a vibration motor vibrates at a base frequency.

5. The method according to claim 2, wherein the interchange format file of the haptic media comprises a data structure of a library haptic event of the haptic media, and the data structure of the library haptic event is configured for defining attribute information of the library haptic event of the haptic media, and comprises a haptic event type field; the haptic event type field is configured for indicating an event type of the library haptic event of the haptic media, and the event type comprises a transient event or a persistent event; and
when the haptic event type field indicates that the event type of the library haptic event of the haptic media is the transient event, and the data structure of the library haptic event further comprises a duration field, the representation information of the transient haptics signal comprises the duration field; the duration field is configured for indicating duration of all transient haptic events in the current haptic pattern,
wherein one haptic pattern has one library haptic event having the duration field and having the event type of the transient event.

6. The method according to claim 5, wherein when the haptic event type field indicates that the event type of the library haptic event of the haptic media is the persistent event, the duration field is configured for indicating duration of a corresponding library haptic event.

7. The method according to claim 3, wherein the data structure of the library haptic event is determined according to a data structure of a haptic event; the data structure of the haptic event contains a reference library event field, the data structure of the library haptic event does not contain the reference library event field, and the reference library event field is configured for indicating a library haptic event identifier corresponding to the haptic event when an event type of the haptic event is a reference event; and
the data structure of the haptic event contains a relative time field, the data structure of the library haptic event does not contain the relative time field, and the relative time field is configured for indicating a time offset of the haptic event.

8. The method according to claim 3, wherein the data structure of the library haptic event is determined according to the data structure of the haptic event, and the data structure of the haptic event contains an amplitude field, a base frequency field, and an event component field; when the haptic event type field indicates that the event type of the library haptic event of the haptic media is the transient event, and the data structure of the library haptic event comprises the duration field, the data structure of the library haptic event does not contain the amplitude field, the base frequency field, and the event component field; and
the amplitude field is configured for indicating a maximum signal amplitude value of the haptic event; the base frequency field is configured for indicating a signal base frequency of the haptic event; the event component field is configured for indicating a haptic event component element list; the haptic event component element list is configured for indicating a component of the haptic event, and the component of the haptic event comprises a time-domain component or a frequency-domain component of the haptic event.

9. The method according to claim 2, wherein the interchange format file of the haptic media comprises the data structure of the haptic event of the haptic media, and the data structure of the haptic event is configured for defining attribute information of the haptic event of the haptic media, and comprises a haptic event type field; the haptic event type field is configured for indicating the event type of the haptic event of the haptic media, and the event type comprises the reference event or an ordinary event; and
when the haptic event type field indicates that the event type of the haptic event of the haptic media is the reference event, the data structure of the haptic event further comprises the reference library event field, and the representation information of the transient haptics signal comprises the reference library event field; the reference library event field is configured for indicating the library haptic event identifier corresponding to the haptic event having the event type of the reference event,
wherein duration of the haptic event having the event type of the reference event is the same as duration of a library haptic event indicated by a corresponding library haptic event identifier.

10. The method according to claim 5, wherein when the haptic event type field indicates that the event type of the haptic event of the haptic media is the ordinary event, the data structure of the haptic event further comprises the relative time field, and the relative time field is configured for indicating the time offset of the haptic event.

11. The method according to claim 1, wherein the acquiring representation information of a transient haptics signal in the haptic media comprises:
acquiring a bitstream file of the haptic media; and
acquiring the representation information of the transient haptics signal from the bitstream file of the haptic media.

12. The method according to claim 11, wherein the bitstream file of the haptic media comprises a haptic pattern metadata packet, and the haptic pattern metadata packet is obtained by encoding haptic pattern metadata; the haptic pattern metadata packet of the haptic media comprises a transient duration field; and
the representation information of the transient haptics signal comprises the transient duration field, and the transient duration field is configured for indicating duration of a transient haptics signal in a current haptic pattern.

13. The method according to claim 12, wherein the haptic pattern metadata packet further comprises a haptic pattern type field, and the haptic pattern type field is configured for indicating a type of a haptic pattern of the haptic media; and
when the haptic pattern type field indicates that the type of the haptic pattern of the haptic media is vibration haptics, the transient duration field is configured for indicating that duration of a transient haptics signal in a current vibration haptic pattern is a quantity of times that a vibration motor vibrates at a base frequency.

14. The method according to claim 11, wherein the bitstream file of the haptic media comprises a library haptic event metadata packet, and the library haptic event metadata packet is obtained by encoding library haptic event metadata; the library haptic event metadata packet comprises an event type field and a duration flag field; the event type field is configured for indicating an event type of the library haptic event, and the event type comprises a transient event or a persistent event; the duration flag field is configured for indicating whether to indicate duration of the library haptic event; and
if the duration flag field indicates that the duration of the library haptic event needs to be indicated, the library haptic event metadata packet further comprises a duration field, and the representation information of the transient haptics signal comprises the duration field; if the event type field indicates that the event type of the library haptic event of the haptic media is the transient event, the duration field is configured for indicating duration of all transient haptics signals in the current haptic pattern,
wherein one haptic pattern has one library haptic event having the duration field and having the event type of the transient event.

15. The method according to claim 14, wherein when the event type field indicates that the event type of the library haptic event of the haptic media is the persistent event, the duration field is configured for indicating duration of a corresponding library haptic event.

16. The method according to claim 1, wherein the acquiring representation information of a transient haptics signal in the haptic media comprises:
acquiring a media format file of the haptic media; and
acquiring the representation information of the transient haptics signal from the media format file of the haptic media.

17. The method according to claim 16, wherein the media format file of the haptic media comprises a haptic pattern description data box, and the haptic pattern description data box is configured for indicating metadata information of the haptic pattern of the haptic media; the haptic pattern description data box comprises a transient duration field; and
the representation information of the transient haptics signal comprises the transient duration field, and the transient duration field is configured for indicating duration of a transient haptics signal in a current haptic pattern.

18. The method according to claim 1, wherein the presenting the transient haptics signal in the haptic media according to the representation information of the transient haptics signal comprises:
rendering the representation information of the transient haptics signal to obtain the transient haptics signal.

19. A computer device, comprising:
a processor, adapted to implementing a computer program; and
a computer-readable storage medium, having the computer program stored therein, the computer program being adapted to being loaded by the processor and performing a method for processing haptic media including:
acquiring representation information of a transient haptics signal in the haptic media, the representation information of the transient haptics signal indicating duration of the transient haptics signal; and
presenting the transient haptics signal in the haptic media according to the representation information of the transient haptics signal.

20. A non-transitory computer-readable storage medium, having a computer program stored therein, the computer program being adapted to being loaded by a processor of a computer device and performing a method for processing haptic media including:
acquiring representation information of a transient haptics signal in the haptic media, the representation information of the transient haptics signal indicating duration of the transient haptics signal; and
presenting the transient haptics signal in the haptic media according to the representation information of the transient haptics signal.
